(19) United States
(12) Patent Application Publication
(10) Pub. No.: US 2007/0056398 A1
(43) Pub. Date: Mar. 15, 2007

(54) Gearbox comprising two clutches and two main shafts

(75) Inventor: Michel Raoul, Elancourt (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: Renault S.A.S, Boulogne Billancourt (FR)

(21) Appl. No.: 10/557,712

(22) PCT Filed: May 17, 2004
(86) PCT No.: PCT/FR04/01214

§ 371 Date: Nov. 22, 2005

(30) Foreign Application Priority Data
May 23, 2003 (FR) 03/06266

(51) Int. Cl. F16H 3/08

(52) U.S. Cl. 74/325

(57) ABSTRACT

A gearbox including parallel shafts and two clutches, more specifically, a solid clutch shaft and a hollow clutch shaft that are concentrically arranged, and two non-concentric main shafts. In the gearbox the first main shaft carries a descending pinion that directly engages with a differential ring gear, and the second main shaft drives the differential ring gear by a driving shaft acting on the first main shaft and by the descending pinion.

The invention relates to a motor-vehicle gearbox.

More particularly, it relates to a gearbox with two parallel shafts and two clutches provided with a concentric solid primary shaft and a hollow primary shaft, and two non-concentric secondary shafts.

This type of gearbox, known from French Patent 2802600, poses a problem of axial space requirement. In addition, the possibilities of adapting its gear range to different power trains are limited. Finally, the base of the gearbox is occupied by one of the secondary shafts, with the result that its pinions create emulsions by splashing in the oil, thus risking serious disturbance of the functioning of the oil pump and of the hydraulic distributor in the case that wet-input clutches are used.

The purpose of the present invention is to remedy the disadvantages of this known gearbox.

With this objective, it proposes that the first secondary shaft carry a descending pinion that acts directly on a differential ring gear and that the second secondary shaft drive the ring gear by the intermediary of a countershaft on the first secondary shaft and of the same descending pinion.

According to another characteristic of the invention, the primary shafts carry a plurality of fixed toothings engaging with idler pinions of one or the other of the secondary shafts, including at least two fixed toothings that engage simultaneously with an idler pinion of each secondary shaft and one fixed toothing that engages simultaneously with a forward idler pinion and with a reverse intermediate pinion.

Finally, the splashing problem of the known gearbox is resolved by the fact that the axes of the primary and secondary shafts define a triangle, whose angle having as vertex the axis of the primary shafts is an upwardly open obtuse angle.

Other characteristics and advantages of the invention will become clear upon reading the description hereinafter of a particular embodiment thereof with reference to the attached drawings, wherein:

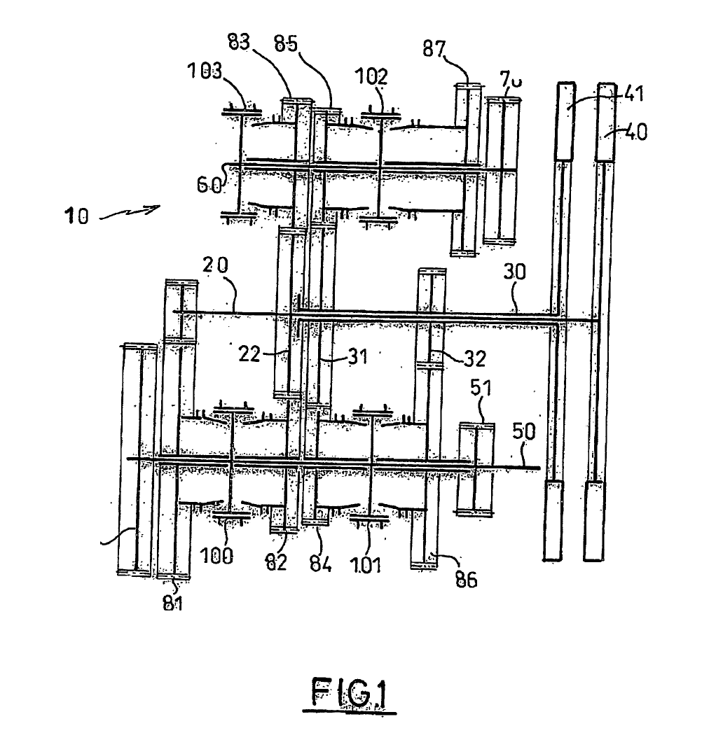

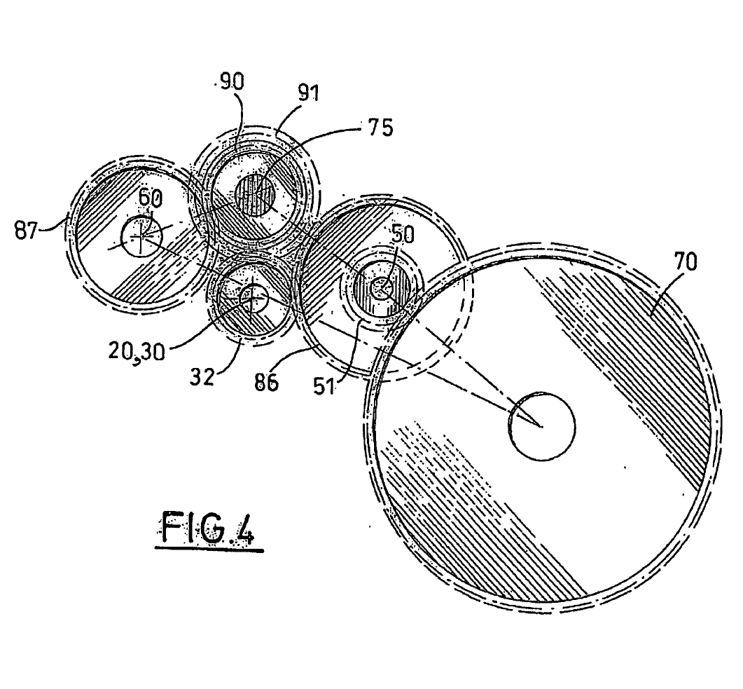

FIG. 1 is a schematic view in section with planes rotated into the plane of projection, according to the line in FIG. 4, passing through the axes of the primary and secondary shafts,

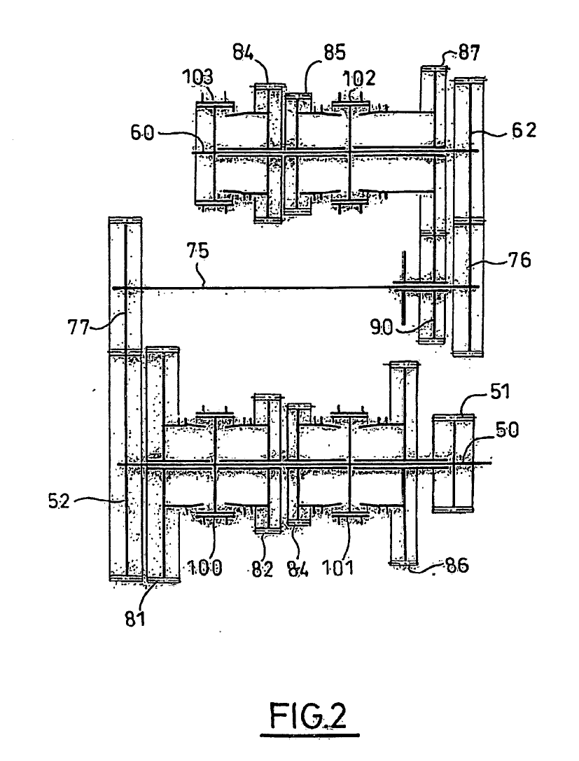

FIG. 2 is a schematic view in section with planes rotated into the plane of projection, according to the line in FIG. 4, passing through the axes of the auxiliary secondary, reverse intermediate, primary and principal secondary shafts,

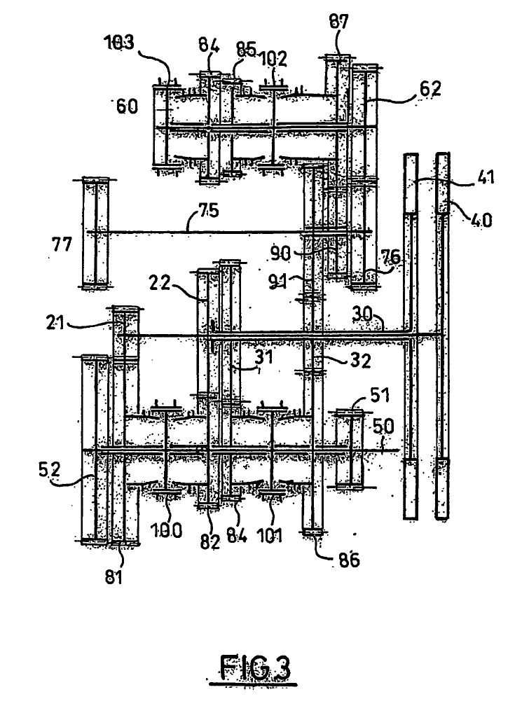

FIG. 3 is a schematic view in section with planes rotated into the plane of projection, according to a line in FIG. 4, passing through the axes of the auxiliary secondary, intermediate counter and principal secondary shafts,

FIG. 4 is a view according to FIG. 2, representing the torque path according to the reverse gear ratio.

FIG. 1 illustrates a schematic view of a gearbox 10 constructed according to the invention.

In known manner, gearbox 10 is provided with a solid first primary shaft 20 that is mounted coaxially with a hollow second primary shaft 30. These two shafts are mounted to rotate in a case (not illustrated) and are driven by an engine, via respectively a first clutch 40 and a second clutch 41 which, for example, are wet multiple-disk clutches but are not limited thereto.

The gearbox is also provided with a first secondary shaft 50 referred to as principal and a second secondary shaft 60 referred to as auxiliary, also mounted to rotate in the case. These secondary shafts are not coaxial. According to the invention, the axes of primary shafts 20, 30 and secondary shafts 50, 60 define a triangle, whose angle having as vertex the axis of primary shafts 20, 30 is an upwardly open obtuse angle. As shown in FIG. 4, the secondary shafts therefore form, with the axes of the primary shafts, a very open V, whose vertex is occupied by the axes of the primary shafts.

Gear trains are disposed between primary shafts 20 and 30 and secondary shafts 50 and 60, in such a way that they transmit the vehicle torque to a ring gear 70 (illustrated in FIG. 4) of a differential of a bridge (not illustrated) driving the wheels of a vehicle. For this purpose, only principal secondary shaft 50 is provided with a descending pinion 51, which engages with ring gear 70 of the differential, and auxiliary secondary shaft 60 is linked in rotation with secondary shaft 50 by countershaft 75 carrying fixed pinions 76 and 77 engaging with fixed pinions 52 and 62 carried respectively by secondary shafts 50 and 60.

The gear trains are composed of fixed toothings carried by first and second primary shafts 20 and 30 and which engage with idler pinions carried by secondary shafts 50 and 60. These idler pinions can be selectively linked in rotation with first and second secondary shafts 50 and 60 by independent claw-coupling means, to achieve independent gear trains corresponding selectively to at least two forward gear ratios and to one reverse gear ratio. The two clutches, 40 of first primary shaft 20 and 41 of second primary shaft 30, can also be actuated alternatively by shifting through a state in which they both transmit the torque by sliding of one of them, to permit at least one change of gear ratio without discontinuity of the torque transmitted to the wheels.

According to the non-limitative embodiment of the invention illustrated by the figures, first primary shaft 20 carries two fixed toothings, 21 and 22 from left to right. The first engages with a single idler pinion 81 carried by first secondary shaft 50, to constitute the first gear ratio. The second engages with two idler pinions 82 and 83, carried respectively by first secondary shaft 50 to constitute the fifth gear ratio and by second secondary shaft 60 to constitute the third gear ratio.

Hollow second primary shaft 30 also carries two fixed toothings, 31 and 32 from left to right. The first engages with two idler pinions 84 and 85, respectively carried by first secondary shaft 50 to constitute the sixth gear ratio, and by second secondary shaft 60 to constitute the fourth gear ratio. The second engages with an idler pinion 86 carried by first secondary shaft 50 to constitute the second gear ratio. The reverse gear ratio has its own idler pinion 87, carried by second secondary shaft 60, which engages with an intermediate pinion 90, carried by intermediate shaft 75, linked in rotation with second intermediate pinion 91, which engages with fixed toothing 32 of primary shaft 30. According to the invention, intermediate pinion 91, 90 turns idly on intermediate shaft 75.

In summary, primary shafts 20, 30 carry a plurality of fixed toothings 21, 22, 31, 32 engaging with idler pinions (81, 82, 83, 84, 85, 86) of one or the other of the secondary shafts (50, 60), of which at least two fixed toothings 22, 31 engage simultaneously with an idler pinion 82, 83, 84, 85 of each secondary shaft 50, 60 and of which one fixed toothing 32 engages simultaneously with a forward idler pinion 86 and with reverse intermediate pinion 91.

This arrangement makes it possible to obtain six forward gear ratios and one reverse gear ratio with only two fixed toothings 21 and 22 on solid first primary shaft 20 to obtain the odd-numbered gear ratios and two fixed toothings 31 and 32 on hollow second primary shaft 30 to obtain the even-numbered gear ratios and the reverse gear ratio. Fixed toothings 22, 31 and 32 each engage with two pinions, the first with idler pinions 82 and 83, the second with idler pinions 84 and 85, the third with idler pinion 86 and reverse intermediate pinion 91.

It is seen in FIGS. 2 and 3 that reverse idler pinion 87, forward intermediate pinion 90 and idler counterpinions 62 and 76 are disposed in the same axial section as driving pinion 51. Thus the gearbox proposed by the invention has the same axial space requirement as a gearbox with four gear ratios, to obtain six forward gear ratios and one reverse gear ratio. It is therefore particularly compact.

The distances between the axes of primary shafts 20, 30 and the two secondary shafts 60 can be different. Nevertheless, they will preferably will be identical. In fact, provided identical claw-coupling devices are also chosen, it is also possible to use identical idler pinions. According to the invention, pinions 82 of the fifth gear ratio and 83 of the third gear ratio can therefore be identical, as can pinions 84 of the sixth gear ratio and 85 of the fourth gear ratio.

Toothed wheels 52 of first secondary shaft 50, 62 of second secondary shaft 60 and 76, 77 of the countershaft can therefore have ratios of the number of teeth appropriate for obtaining different gear ratios from a fixed toothing that engages with two identical idler pinions.

To obtain the fifth and third gear ratios from single fixed pinion 22 and identical idler pinions 82 and 83, the combined numbers of teeth of pinions 62 and 76 on the one hand and 77 and 52 on the other hand yield, for example, a significant gear reduction ratio on the order of 1.4 to 1.7. The same is true for obtaining sixth and fourth gear ratios from single fixed pinion 31 and identical idler pinions 84 and 85.

Finally, to obtain a satisfactory gear range of the third to sixth gear ratios, it is advantageous to choose a ratio of teeth between fixed pinions 22 and 31 such that the ratios between the gear reductions of third to fourth, of fourth to fifth and of fifth to sixth are identical or substantially identical.

First and second clutches 40 and 41 make it possible selectively to link to the engine solid first primary shaft 20 carrying fixed toothings 21 and 22 of the odd-numbered gear ratios and hollow second primary shaft 30 carrying fixed toothings 31 and 32 of the even-numbered gear ratios. In addition, all the idler pinions can be selectively linked to the secondary shafts carrying them by single or double claw-coupling devices. Thus idler pinions 81, 82, 84 and 86 can be linked selectively to secondary shaft 50 carrying them and idler pinions 83, 85 and 87 can be linked selectively to secondary shaft 60 carrying them.

A first double claw-coupling device 100 makes it possible selectively to link idler pinion 81 in rotation to secondary shaft 50 to obtain the first gear ratio or to so link idler pinion 82 to obtain the fifth gear ratio. A second double claw-coupling device 101 makes it possible to link idler pinion 84 in rotation to secondary shaft 50 to obtain the sixth or to so link idler pinion 86 to obtain the second gear ratio. A third double claw-coupling device 102 makes it possible selectively to link idler pinion 85 in rotation to secondary shaft 60 to obtain the fourth gear ratio or to so link idler pinion 87 to obtain the reverse gear ratio; finally, a single claw coupling 103 makes it possible selectively to link idler pinion 83 in rotation to secondary shaft 60 to obtain the third gear ratio.

FIG. 4 illustrates the torque path from the engine to the differential ring gear via the reverse gear ratio. The torque is transmitted from the engine to primary shaft 30 by closed clutch 41, then from fixed toothing 32 to first reverse intermediate pinion 91 linked to second intermediate pinion 90, then from second reverse intermediate pinion 90 to reverse idler pinion 87, which transmits it to secondary shaft 60 by the intermediary of double claw coupling 102 in coupled position on pinion 87, then from secondary shaft 60 to pinion 62, then to fixed pinion 76 of intermediate countershaft 75, then from intermediate countershaft 75 to fixed pinion 77, which transmits the movement to fixed pinion 52 of principal secondary shaft 50, which transmits it by the intermediary of driving pinion 51 to ring gear 70.

The torque path is similar for the third and fourth gear ratios, since idler pinions 83 and 85 are carried by auxiliary secondary shaft 60.

The torque path from the engine to the differential ring gear in the first gear ratio can be the following. The torque is transmitted from the engine to primary shaft 20 by closed clutch 40, then from fixed toothing 21 to idler pinion 81, then from idler pinion 81 to secondary shaft 50 by double claw coupling 100 in coupled position on pinion 81, then from secondary shaft 50 to fixed pinion 51, which transmits it to ring gear 70.

The torque path is similar for the fifth, sixth and second gear ratios, since idler pinions 82, 84 and 86 are carried by auxiliary secondary shaft 50.

Finally, it must be emphasized that the shift from a given gear ratio to the immediately higher gear ratio relies in all cases on a change of clutch and of primary shaft. This is in fact the condition for achieving changes of gear ratio without discontinuity of the engine torque, by simultaneous actuation of two clutches.

1-10. (canceled)

11. A gearbox comprising:
parallel shafts and two clutches provided with a concentric solid primary shaft and a hollow primary shaft and first and second non-concentric secondary shafts,
wherein the first secondary shaft carries a descending pinion acting directly on a differential ring gear and the second secondary shaft drives the ring gear by an intermediary of a countershaft on the first secondary shaft and of the descending pinion.

12. A gearbox according to claim 11, wherein the intermediate shaft carries two fixed pinions engaging respectively with a fixed pinion of the first secondary shaft and with a fixed pinion of the second secondary shaft.

13. A gearbox according to claim 11, wherein the intermediate shaft carries a reverse intermediate pinion engaging with a fixed toothing of the hollow primary shaft and with a reverse idler pinion configured to be claw-coupled with one of the secondary shafts.

14. A gearbox according to claim 13, wherein the intermediate pinion turns idly on the intermediate shaft.

15. A gearbox according to claim 11, wherein the primary shafts carry a plurality of fixed toothings engaging with idler pinions of the secondary shafts, including at least two fixed toothings that engage simultaneously with an idler pinion of each secondary shaft and one fixed toothing that engages simultaneously with a forward idler pinion and with a reverse intermediate pinion.

16. A gearbox according to claim 12, including six forward gear ratios, and wherein a reduction ratio of the fixed pinions ensuring transfer of the movement between the two secondary shafts gives the ratio of the fourth to the sixth gear ratio or that of the third to the fifth gear ratio.

17. A gearbox according to claim 11, wherein axes of the primary shafts and secondary shafts define a triangle, whose angle has as a vertex the axis of the primary shafts as an upwardly open obtuse angle.

18. A gearbox according to claim 11, wherein the descent of clutches of the second secondary shaft onto the intermediate shaft is located in a same axial space as the driving pinion.

19. A gearbox according to claim 11, wherein the primary shafts are equidistant from axes of the secondary shafts.

20. A gearbox according to claim 16, wherein toothings of the idler pinions of the fourth and sixth gear ratios are identical.
